(19) United States
(12) Patent Application Publication
(10) Pub. No.: US 2020/0401988 A1
(43) Pub. Date: Dec. 24, 2020

(54) EzSort: EzGarment Assembly and Sorting System

(71) Applicants: David H. Brown, Wauchula, FL (US); Diane L. Rue, Sarasota, FL (US)

(72) Inventors: David H. Brown, Wauchula, FL (US); Diane L. Rue, Sarasota, FL (US)

(21) Appl. No.: 16/870,949

(22) Filed: May 9, 2020

Related U.S. Application Data
(60) Provisional application No. 62/865,518, filed on Jun. 24, 2019.

(51) Int. Cl. G06Q 10/08; D06F 93/00; G06Q 30/00; G06Q 10/06; G06K 7/14; A47F 7/24

(52) U.S. Cl. CPC G06Q 10/087; D06F 93/00; G06Q 30/0185; G06Q 50/28; G06K 7/1413; A47F 7/24; G06Q 10/063114

(57) ABSTRACT

A clothing rack has a first rail and a second rail extending upwards from an integral floor support member. A housing is moveably attached to the first rail and to the second rail using two housing support members. A storage member is integrally attached between the first rail and the second rail. The housing has a plurality of visual indicators located on it for indicating the location of garments on a storage member disposed underneath it. A computer system and associated database facilitates the entry of new customer information, the movement of an item within the business operations to process the customer order and the delivery thereof. Various implementations of multiple combination of EzSort Systems are presented.

### FIELD OF THE INVENTION

The present invention relates to the cleaning industry; more particularly, the present invention relates to a method, system and apparatus that is used in the assembly, organization, selection, and transfer of clothing and other textile materials in a cleaning business.

### BACKGROUND OF THE INVENTION

### Prior Art Dry Cleaning

Dry cleaning is a cleaning process using a chemical solvent other than water for cleaning of clothes and textile materials. These are inserted within a cleaning basket or drum chamber constituting the core of the machine. This washing chamber contains a perforated drum that rotates within an outer shell. The shell holds the solvent while the rotating drum holds the garment load. The chamber is filled approximately one-third full of solvent and begins to rotate, agitating the clothing. During the wash cycle, the solvent in the chamber is passed through a filter and then fed back into the system. This is known as the cycle and is continued for the wash duration. Next begins a rinse cycle where the garment load is rinsed with freshly distilled solvent dispensed from the solvent tank and after this an extraction process recovers almost all of the solvent for reuse.

The final major step in the drying process is the drying cycle; at this point the garments are tumbled in a stream of warm air that circulates through the basket, evaporating traces of solvent left after the spin cycle. The air temperature is controlled to prevent heat damage to the garments. The exhausted warm air from the machine then passes through a chiller unit where solvent vapors are condensed and returned to the distilled solvent tank. Modern dry cleaning machines use a closed-loop system in which the chilled air is reheated and recirculated. This results in high solvent recovery rates and reduced air pollution.

### Prior Art Assembly Systems

After the item of clothing is cleaned it is organized using an assembly device as shown in FIG. 1A. A traditional assembly tool for cleaning is a hanger upon which an article of clothing is placed by a cleaning worker in order to assemble the particular order for a client. Each of the hangers is then placed upon a rack or bar storage. The Z Bar (or Z Rack) is a device typically constructed from metal like aluminum, steel or similar types of material that has been welded, bolted together or otherwise attached together.

At the bottom of the device is a Z shaped member 1 having two outer legs and an intervening diagonal leg. This Z shaped member (generically, a floor support member) has a group of casters (four in the drawing) attached at each sharp point of the ‘Z’ on one side thereof to form a carriage system thereby facilitating the motion of the Z Bar (or Z Rack) device. Two vertical bars 2, 3 are attached one to the first outer leg and the other to the other outer leg of the ‘Z’ extending upwards and connected together at top with a horizontal bar 4 that serves as a hanger storage bar. Each of the hangers in such a system must be lifted off individually. The hangers are an important part of the process of properly locating clothing on the bar or rack, how clothing is grouped together and identifying where an entire order or unique parts of a client order are for final delivery.

When a customer initially drops off the order they receive a claim ticket that matches a uniquely identifiable label placed with the order. In the modern era, this uniquely identifiable label is a scannable label attached to a plastic sheath about the clothing or textile item and or attached directly to the clothing item itself. Traditionally, dry cleaning establishments have a customer service area in which the customer drops off the clothes to be cleaned and receives a claim ticket to retrieve the clothes after they have been cleaned. Once cleaned, pressed and or folded the clothing is placed on hangers but the various items are interspersed with items from other customers; thus, a correlation between items from the same customer order takes place so as to arrange all of the items of a particular customer order ticket at a common convenient location on the Z bar or Z Rack.

However, a problem has arisen in that it is time consuming in a high volume dry cleaning system to sort each of the items without a visual or auditory indication of the sorting process in the loading and unloading of the clothing from a distribution or storage system such as a rack. Further, there is no device or system by which a group of items can be arranged simply so as to ensure the proper arrangement of the items of a single ticket.

Additionally, there is no system by which the temporary storage of an assembly location such as a hanger can be arranged to facilitate the movement of the assembly location from one temporary storage unit such as a rack to another temporary storage location for transport within a building or to and from vehicles for transport. Finally, there is no mechanism by which a cleaning employee can use to ensure that each step in the process is authenticated and that the proper items are stored appropriately.

US Patent Documents

U.S. Pat. No. 10,207,293 to Fanaian et al. teaches an LED Assisted Rapid Assembly system wherein a plurality of rack locations are provided with an addressable LED light puck at each location, such that the puck may be illuminated to indicate to a worker the rack location for a specific garment by correlating the garment, the invoice/ticket and the location electronically and controlling the LED.

### SUMMARY OF THE INVENTION

The present invention overcomes the deficiencies of the known art and the problems that remain unsolved by providing an EzSort: EzGarment Assembly and Sorting System and Toolkit for dry cleaners' POS software.

A cleaner sorting system comprising:

a storage rack having a first rail and a second rail attached together using a floor support member of the storage rack;

a storage member attached to the first rail and to the second rail;

a housing movably and permanently attached to the first rail and the second rail; wherein the housing has a visual indicator on an external surface thereof.

In another aspect,
a first bracket attached to the first rail and a second bracket attached to the second rail.

In another aspect,
a separator attached between the first bracket and the second bracket.

In another aspect,
an axle attached to the first rail and to the second rail.

In another aspect,
a housing support member attached to the housing and to the axle.

In another aspect,
a cam mounted on the axle and in contact with the housing support member.

In another aspect,
a cam attached to an axle that is attached to the first rail and the second rail, wherein the cam is in contact with
a housing support member attached to the housing and to the axle; characterized in that user actuated cam motion moves the housing into an UP or into a DOWN position.

In another aspect,
wherein the housing further comprises a movable housing that moves between:
a housing UP position and a housing DOWN position.

In another aspect,
whereby the housing UP position does not impact the storage member.

In another aspect,
a flange extending from a bottom portion of the housing.

In another aspect, wherein the flange further comprises:
a dual flange having a forward flange and rear flange with a space there between.

A product control system for order completion comprising:

a housing having a plurality of indicators, each indicator provides a human sensible indication of customer order status;

a plurality of delivery separators integrally associated with the housing, each delivery separator of said plurality of delivery separators has an indicator of the plurality of indicators associated with it;

a customer specific tag to be applied to each item of the order presented by a customer;

a computer including an operator interface and an output to each of said plurality of indicators, said operator interface including an input device allowing an operator to identify a customer and an item associated with said customer; and

a scanning device capable of reading each customer specific tag and providing an input to said computer that said customer specific tag has been scanned.

In another aspect,
a plurality of flanges extending from a bottom portion of the housing.

In another aspect,
a dual flange having a forward flange and rear flange with a space there between.

A method for sorting and assembling items prepared for delivery to a customer comprising:

associating an item specific, customer specific identification tag on each item to be prepared;

entering each item identification into a computer control system and monitoring the progress of each item in the preparation process; wherein each item forms a portion of an order identifiable with a specific customer;

processing all items to be prepared;

retrieving an item that has been prepared and using said tag to identify the item to the computer control system;

activating a human sensible indicator integrally and directly associated with a movable housing movably attached to a rack, wherein the human sensible indicator at the movable housing is above an assembly location for items on the rack for items belonging to a particular order such that a human operator may move the retrieved item to the assembly location;

repeating the retrieving an item and the activating a human sensible indicator steps above until all items in a particular order have been assembled; and

activating a human sensible indicator on said assembly location to indicate the order is complete.

In another aspect, further comprising: prepared for delivery to a customer wherein the movable housing is moved into an up position.

In another aspect, wherein said human sensible indicator is an addressable LED.

In another aspect, wherein said addressable LED is addressable by said computer control system.

In another aspect, wherein said addressable LED is illuminated for a preset period of time to allow said operator to move said item to the associated location.

In another aspect, wherein said computer control system includes a graphical user interface displaying the status of selected open orders and garments being retrieved, wherein said graphical user interface displays the assembly location and the items retrieved to said assembly location.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1A presents a prior art assembly device, a Z Bar or Z Rack used for the temporary storage of one or more customer orders loaded with the primary assembly device, i.e., a hanger having clothing loaded thereon.

FIG. 1B presents an EzBar for the easy loading and off loading of garments upon their own storage hanger (i.e., primary assembly device); the EzBar also has end caps for protection of the hangers stored thereon from sliding off during transport within a business, in a vehicle or similar part of the transport process in an embodiment disclosed herein.

FIG. 1C presents an end cap used with the EzBar and various other devices in an embodiment disclosed herein.

FIG. 1D presents the EzBar being transformed into an EzSort such that there is an EzSort mounting bracket for the attachment of an EzSort housing in an embodiment disclosed herein.

FIG. 1E presents the separator bar or separator for short as taught in an embodiment disclosed herein.

FIG. 1F presents a closeup of an end of the separator bar or separator for short as taught in an embodiment disclosed herein.

FIG. 1G presents an EzBar having an EzSort mounting hinge attached to a bracket so that the EzSort housing is moved using a lever assembly attached to the bracket. The EzSort housing has an addressable set of LEDs, push button actuators for the LEDs, a group of dividers formed as flanges that are integral with a bottom portion of the housing and extending out therefrom in an embodiment disclosed herein.

FIG. 1H presents a closeup of the EzSort mounting hinge and a lever assembly, EzSort housing having a set of LEDs, push button actuators as well as the group of separator flanges in an embodiment disclosed herein.

FIG. 1I presents an EzBar with bottom vertical rail supports and holes 8C for coupling multiple EzBars and or EzSorts together in an embodiment disclosed herein.

FIG. 1J presents a rotated bottom assembly view of the EzBar showing connection of a vertical rail to the Z base in an embodiment disclosed herein.

FIG. 1K presents a closeup of a bottom support for the vertical rails in an embodiment disclosed herein.

FIG. 2A presents a portion of the EzSort system having a storage member, a separator bar or separator for short, axle, and lever assembly attached to a mounting bracket whereby the EzSort housing (not shown) separator flanges may be moved atop the storage bar and moved away therefrom depending upon user actuation of the lever assembly in an embodiment disclosed herein.

FIG. 2B presents a closeup perspective view of the axle, bracket, lever assembly, separator, and storage member such that the lever assembly is attached to a bracket in a portion of an EzSort system in an embodiment disclosed herein.

FIG. 2C presents an assembly view of the axle 14 in association with various components of the lever assembly at either end thereof in an embodiment disclosed herein.

FIG. 2D presents a closeup assembly view of the axle and lever assembly in an embodiment disclosed herein.

FIG. 2E presents a side view of a portion of the EzSort system having a bracket attached at top thereof with a lever assembly also attached thereto in an embodiment disclosed herein.

FIG. 2F presents a closeup side view of a mounting bracket attached to a top curved portion of a rail having the storage member also attached to the rail in a portion of an EzSort system in an embodiment disclosed herein.

FIG. 2G presents a closeup side view of a mounting bracket in an embodiment disclosed herein.

FIG. 3A presents an opposite side view (from that of FIG. 2E) of the Housing DOWN Position showing an EzSort housing attached to a bracket through a hinge whilst a lever assembly is attached to a mounting bracket that in turn is attached to a rail; this is repeated on other side with other rail, axle end and lever assembly in an embodiment disclosed herein.

FIG. 3B presents a closeup opposite side view of the Housing DOWN position of the EzSort housing having its divider flanges abutting a clothing storage member; the EzSort housing is attached through a hinge (pin) to a bracket on the EzSort through a housing support member attached to the outside of the EzSort housing and to the aforementioned hinge (pin); this is repeated with another bracket, hinge (pin), housing support member on the other side of the EzSort housing in an embodiment disclosed herein.

FIG. 3C presents an opposite side view of the Housing UP Position showing an EzSort housing attached to a bracket through a housing support member and hinge (pin) and moved by a lever assembly attached to a bracket that in turn is attached to a rack rail in an embodiment disclosed herein.

FIG. 3D presents a closeup opposite side view of the EzSort housing having its divider flanges not abutting a clothing storage member in the Housing UP position; the EzSort housing is attached to a bracket using a hinge (pin) and housing support member attached to the outside of the EzSort housing, whilst a lever assembly is also attached to the bracket that in turn is attached to a rail; this is all reproduced on the other side of the EzSort housing in an embodiment disclosed herein.

FIG. 3E present a closeup top assembly view of a portion of the EzSort system whereby a hinge (pin) is attached to a bracket and likewise attached to a housing support member of the EzSort housing; this is all reproduced on the other side of the EzSort housing in an embodiment disclosed herein.

FIG. 3F presents an opposite side view of a housing support member in an embodiment disclosed herein.

FIG. 4A presents an empty EzSort System in an embodiment disclosed herein.

FIG. 4B presents a partially loaded EzSort System in an embodiment disclosed herein.

FIG. 4C presents a partially loaded EzSort System ready to transfer textiles and or clothing to an EzBar through a temporary coupling in an embodiment disclosed herein.

FIG. 4D presents a rotated front view of the coupling used to temporarily connect an EzBar to an EzSort system or to connect several EzSorts together or to connect several EzBars together in an embodiment disclosed herein.

FIG. 4E presents an empty EzSort System after having transferred textiles and or clothing to a now partially loaded EzBar through a temporary coupling in an embodiment disclosed herein.

FIG. 4F presents an empty EzSort System after having transferred textiles and or clothing to an EzBar and after having decoupled from a partially loaded EzBar in an embodiment disclosed herein.

FIG. 5A presents an extended system whereby multiple EzSort Systems are connected together in a first alternative connection embodiment disclosed herein.

FIG. 5B presents another extended system whereby multiple EzSort Systems are connected together in a second alternative connection embodiment disclosed herein.

FIG. 5C presents another extended system whereby multiple EzSort Systems are connected together in a third alternative connection embodiment disclosed herein.

FIG. 5D presents a long floor bar 26 having two threaded ends disposed at 45 degree angles to make a ninety degree system; the angles could be modified as desired in an embodiment disclosed herein.

FIG. 5E presents a short floor bar 27 having two threaded ends disposed at 45 degree angles to make a ninety degree system; the angles could be modified as desired in an embodiment disclosed herein.

FIG. 5F presents an oblique long floor bar 29 having two threaded ends disposed at oblique angles to make an oblique degree system; the angles could be modified as desired in an embodiment disclosed herein.

FIG. 5G presents an oblique short floor bar 30 having two threaded ends disposed at oblique angles to make an oblique degree system; the angles could be modified as desired in an embodiment disclosed herein.

FIG. 5H presents a floor bar 32 having two threaded ends disposed linearly to make a linear system in an embodiment disclosed herein.

FIG. 5I presents an EzBar having clothes mounted on its storage member using assembly locations (hangers) attached to a van rail in an embodiment disclosed herein.

FIG. 5J presents an EzBar after having clothes transferred from its storage member using assembly locations (hangers) to a van having an attached van rail in an embodiment disclosed herein.

FIG. 5K presents a closeup view of EzTransfer Bar 73. The EzTransfer bar 73 is made from a hollow metal component in an embodiment disclosed herein.

FIG. 6A presents a closeup of various LEDs and buttons on the EZSort housing in an embodiment disclosed herein.

FIG. 6B presents a closeup view of a front panel of the EzSort system housing having a group of numerical location indicators, a set of LEDs and a set of push buttons so that each one of the set of LEDs is associated with a single numerical location indicator and a single push button in an embodiment disclosed herein.

FIG. 6C presents a modified EzBar formed as an equipment storage system in an alternative embodiment disclosed herein.

FIG. 6D presents a computer such as a POS point of sale computer that has been attached to the top of the vertical rail in an embodiment disclosed herein.

FIG. 6E presents an exploded assembly view of how the POS point of sale computer has been attached to the top of the vertical rail in in an embodiment disclosed herein.

FIG. 6F presents how NFC/USB communication between a modified EzBar equipment storage and the EzSort system for button, scanner and printer actions in an embodiment disclosed herein.

FIG. 7A presents a flowchart process of the loading of the EzSort system in an embodiment disclosed herein.

FIG. 7B shows an electronic circuit block diagram describing the various components in the EzSort system housed in the EzSort housing or attached thereto as described in an embodiment disclosed herein.

FIG. 7C shows a flowchart method for sorting and assembling items prepared for delivery to a customer in an another embodiment disclosed herein.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

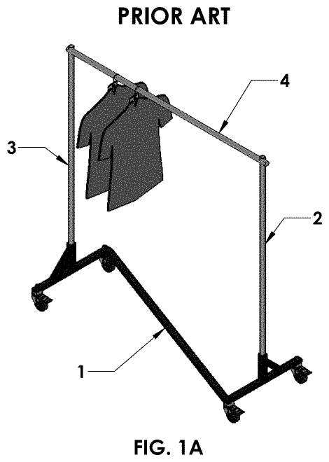

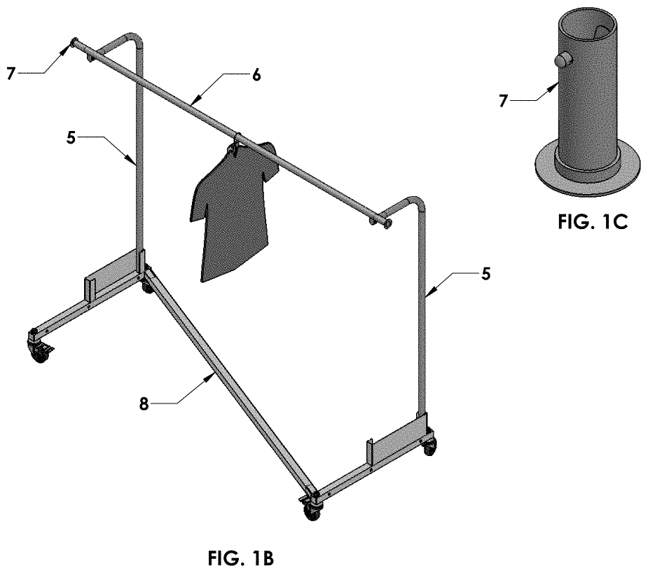

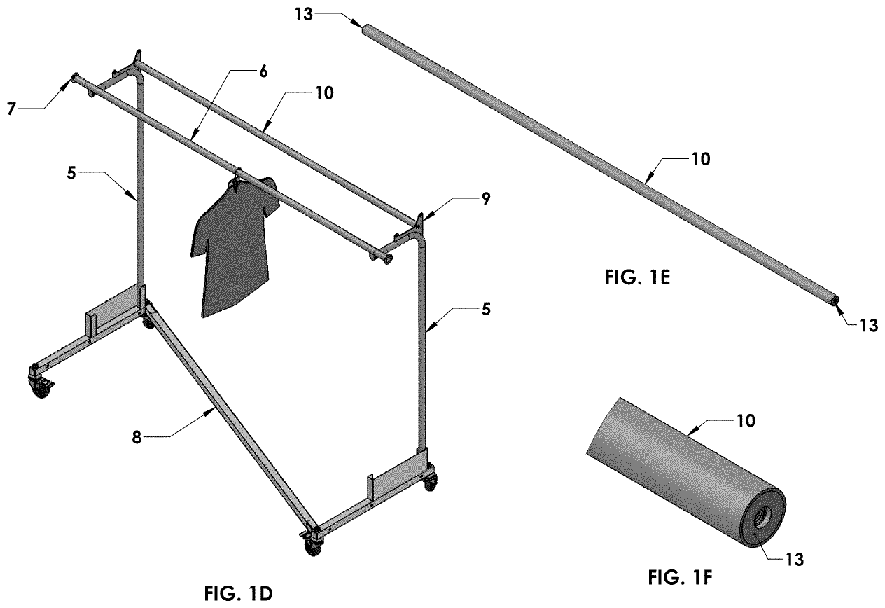

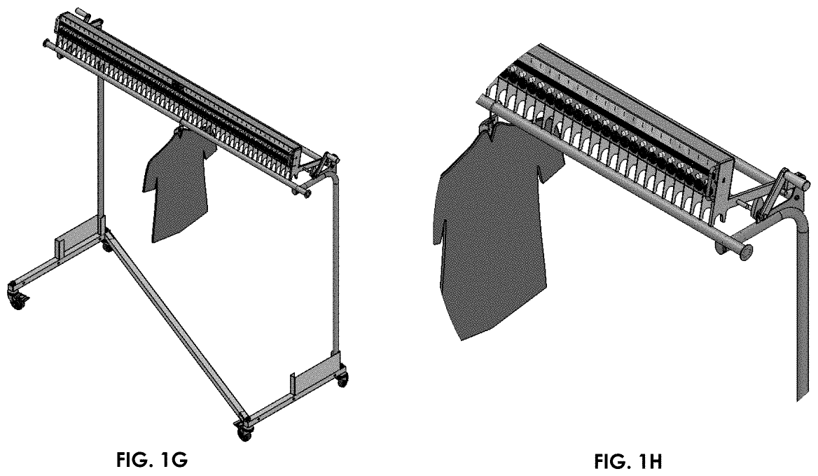

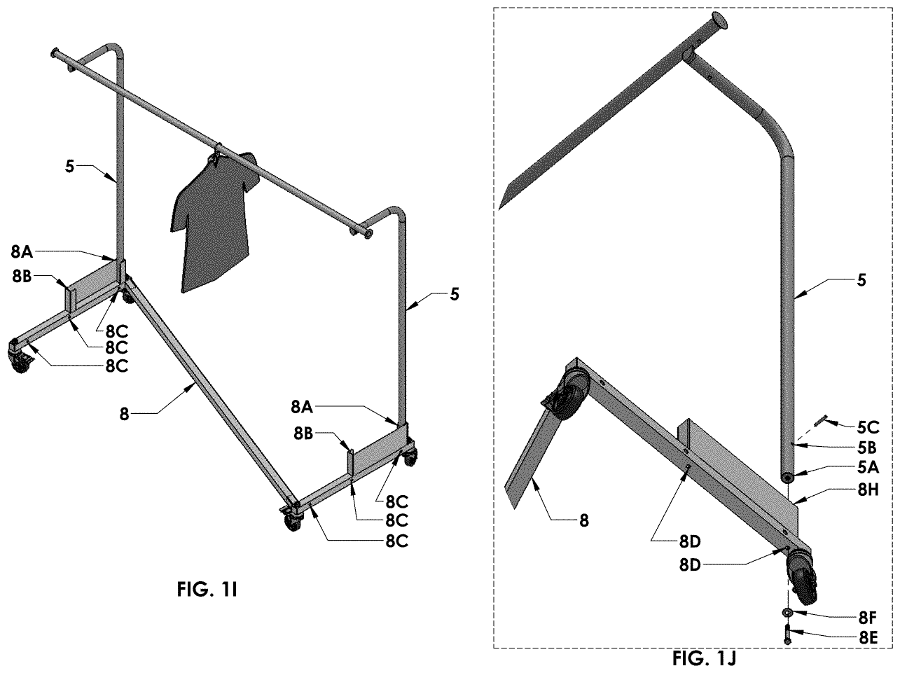

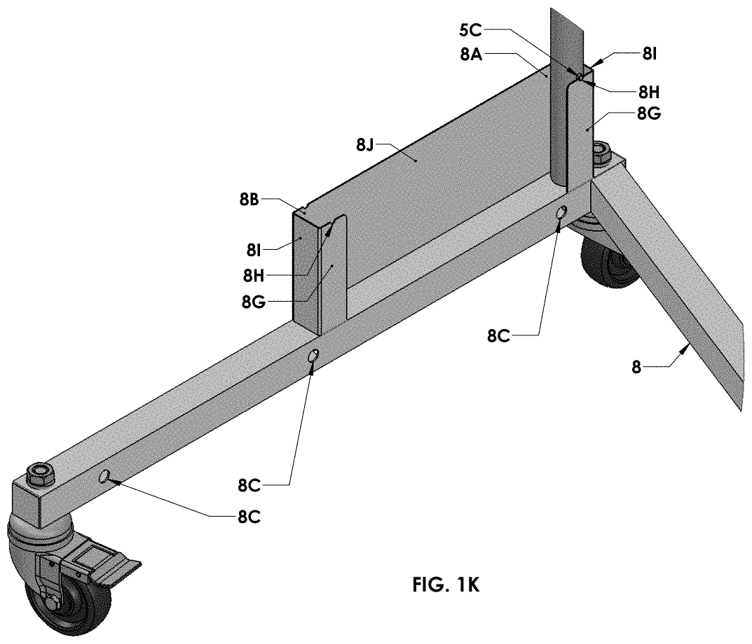

FIG. 1B presents an EzBar for the easy loading and off loading of garments upon their own storage hanger; the EzBar also has end caps for protection of the hangers stored thereon from sliding off during transport within a business, in a vehicle or similar part of the transport process in an embodiment disclosed herein. An EzBar has a Z shaped member 8 having a plurality of casters attached to its underside. The Z shaped member 8 has two outer legs and an integral interconnecting diagonal member. In this application the Z shaped member will be referred to as the Z shaped member or the base.

Two vertical rails 5 are attached to the base 8; one vertical rail 5 is attached near a first sharp end of the base 1 on a first leg thereof (proximal to the diagonal member); and the other vertical rail 5 is attached to a second sharp end of the base 8 on a second leg thereof (distal from the diagonal member). Further, supporting buttresses are shown between each associated base 8 leg to the nearby single one of the rails 5. These, two vertical rails 5 turn inward at the top horizontally toward the centerline of the base. The top portion of the rails 5 are curved inwards toward the centerline of the base 8.

A storage member (or bar) 6 is welded, bolted (bolt-nut combo through holes in the bar and associated rails) or otherwise attached to the horizontal top portion of the two vertical rails 5 for the placement of hangers thereon. The storage member 6 has two hollowed out ends or is a cylinder down its entire length. Two removable end caps 7 each have an integral central barrel and a circular flanged head larger than the central barrel; these caps 7 are inserted within these hollowed out ends (or cylinder ends) one to each end to prevent hangers from sliding off the storage member 6. Alternatively, the end caps 7 have threads on the barrel or cylinder thereof that match corresponding threads within the ends of the storage member 6. Two supporting buttresses are shown providing structural support between the base 8 and only one for each rail 5.

FIG. 1C presents an end cap used with the EzBar and various other devices in an embodiment disclosed herein. The end cap 7 has an opening at an end opposite the circular flanged head thereby revealing a hollow inner portion of the barrel. Within this hollow inner portion of the barrel is situated a snap button; the snap button is welded, brazed, via bolts (-nuts) or soldered to the inner portion of the barrel and or placed within a depression on the surface of the inner portion of the barrel suitable for this purpose. The head of the snap button protrudes out through a hole in the barrel of the end cap 7. This enables the snap button head to engage a corresponding hole in each end of the storage member (or bar) 6 facilitating engagement therewith; one end cap 7 for each end of the storage member 6. Of course, to detach the end cap 7 from the storage member (or bar) 6, a user need only press the head thereof when it is mated to the storage member thereby releasing it from the same.

FIG. 1D presents the EzBar being transformed into an EzSort; here there are two EzSort mounting brackets 9 thereby attaching an EzSort housing therewith; the drawing also shows the use of a horizontal separator 10 rod or bar (hereinafter the separator) in an embodiment disclosed herein. This drawing shows how the EzBar is transformed into an EzSort by the addition of items described herein including but not limited to a Lever Assembly, EzSort housing, electronics, LEDS, buttons, dual flanges, mounting brackets, hinge pins, support member and so forth. The mounting brackets 9 are attached to the horizontal and or top portion of the rails 5 so that each bracket 9 is attached to only one of the horizontal portions and or top portion of one of the rails; thus, a first bracket 9 is attached to only rail 5 and the second bracket is only attached to the other rail 5. These are attached via bolts (-nuts), welding or similar modalities. The separator 10 is attached to provide stability to the system between a rear portion of each bracket 9 so that one end of the separator 10 is attached to a rear portion of a bracket 9 and the other end of the separator 10 is attached to a rear portion of the other bracket 9 using welding, bolt nuts and or other modalities. An end cap 7 is inserted at each end of storage member or bar 6 and attached using the snap button locks there between. The snap button are referred to as locks or snap buttons herein.

FIG. 1E presents the separator as taught in an embodiment disclosed herein. The separator has an annular end for insertion of a bolt for welding or screwing into a threaded hole therein.

FIG. 1F presents a closeup of an end of the separator as taught in an embodiment disclosed herein. Separator 10 has two nut plates 13 attached by welding one to either end of the separator 10; these are welded and then ground flush. The cavity in the nut plates 13 has threads therein so as to mount a screw inserted within a hole at a rear portion of one bracket 9 so that one nut plate 13 is attached directly to one bracket 9 using the first screw and the other nut plate 13 is attached similarly to a hole at a rear portion of the other bracket 9 using another screw.

FIG. 1G presents an EzBar transformed into an EzSort having an EzSort mounting hinge attached to a bracket so that the EzSort housing is moved using a lever assembly attached to the bracket. The EzSort housing has an addressable set of LEDs, push button actuators for the LEDs, a group of dividers formed as flanges that are integral with a bottom portion of the housing and extending out therefrom in an embodiment disclosed herein. In the figure are shown a plurality of assembly locations, in this case hangers, having various clothing items mounted thereon. Each of the assembly locations is loaded upon a storage member or bar of the EzSort system.

FIG. 1H presents a closeup of the EzSort mounting hinge, lever assembly, EzSort housing set of LEDs, push button actuators as well as the group of dividers (or flanges) in an embodiment disclosed herein.

FIG. 1I presents an EzBar with bottom vertical rail supports and holes 8C for coupling multiple EzBars and or EzSorts together in an embodiment disclosed herein. The base 8 of an EzBar (shown) or EzSort (not shown) has a diagonal interconnecting member that is integrally attached to or formed with two outer legs such a Z shape is created thereby. The two outer legs each have three holes for the creation of multi-stage EzBars and or EzSorts as applicable to an implementation.

Also, there are two rail supports formed as vertical thin plates such that the outer surface of each plate is disposed upon the outer surface of a particular one leg. Thus, the main portion of the first rail support is formed on the outer surface of the first leg and the main portion of the second rail support is formed on the outer surface of the second leg by welding, soldering, brazing, bolting or similar attachment mechanisms. The outer longitudinal surface of the first leg being defined as the longitudinal face that is furthest to the outer longitudinal surface of the second leg and parallel thereto and similarly for the second leg.

A first and second L shaped structure is attached (welding, soldering, brazing, bolting or similar attachment mechanisms) one to a free end of the vertical plate and to the top longitudinal surface of the leg; and the other L structure is attached similarly to the opposite end thereof of a vertical plate such that it wraps around the bottom portion of a rail 5 and to the top longitudinal surface of the leg. Both rail supports have the same structure having a separate plate and two L shaped structures to provide rigidity to the rail to which it is attached. Notches on the top of the supports are shown as 8A, 8B.

FIG. 1J presents a rotated bottom assembly view of the EzBar showing connection of vertical rails to the Z base in an embodiment disclosed herein. A typical vertical rail 5 is connected to the top of an EzBar or EzSort leg using a bolt 8E placed inside of washer 8F; the bolt 8E goes through a hole 8D in the bottom of a longitudinal leg and therethrough into a threaded hole in a nut plate 5A formed in a hollowed out portion of the bottom of rail 5 (similar to FIG. 1E, 1F, 13). The nut plate is attached by welding then ground flush.

A through hole 5B at a lower portion of typical rail 5 is for the insertion of a dowel pin 5C that sits atop of notch 8H in the top of a given vertical plate thereby correctly situating the rail 5.

FIG. 1K presents a closeup of a support (top left FIG. 1I) which in an embodiment disclosed herein. A given bottom support forms a buttress for assisting in the rigidity of a given rail 5 as it attaches to the base 8. The support typically has a vertical main plate 8J and dual L shaped structures formed from two components 8I, 8G integrally attached to the vertical main plate 8J at two ends thereof and to the top surface of a longitudinal leg. Thus, the main portion of a given rail support is formed as a vertical thin main plate 8J such that the outer surface of each plate is disposed upon the outer surface of a particular one leg. Thus, the main portion of a first rail support is formed on the outer longitudinal surface of the first leg and the main portion of a second rail support is formed on the outer longitudinal surface of the second leg by welding, soldering, brazing, bolting or similar attachment mechanisms. The outer longitudinal surface of the first leg being defined as the longitudinal surface that is furthest to the outer longitudinal surface of the second leg and parallel thereto and similarly for the second leg.

A first and second L shaped structure is attached (welding, soldering, brazing, bolting or similar attachment mechanisms) one to a free end of the vertical plate and to the top longitudinal surface of the leg; and the other L structure is attached similarly to the opposite end thereof of the vertical main plate such that it wraps around the bottom portion of a rail 5 and to the top longitudinal surface of the leg. Both rail supports have the same structure having a separate vertical main plate and two L shaped structures to provide rigidity to the rail to which it is attached. Notches on the top of the support's vertical main plate 8J are shown as 8A, 8B typically used for dowel pins (optional) when a rail is attached thereto; notches 8H are for attachment of a dowel pin 5C in rail hole 5B on one side and on the other side; it should be understood that notches 8A, 8B are optionally used if pin is long enough and the rail holes 5B pass completely through, or alternatively through the use of another pin.

The L structure is formed from a transverse connecting plate 8I and a small flange plate 8G such that 8I is attached to main plate 8J along a vertical edge thereof and to a vertical edge of 8G. Both are similarly attached to the top longitudinal surface of the particular leg upon which is formed the support.

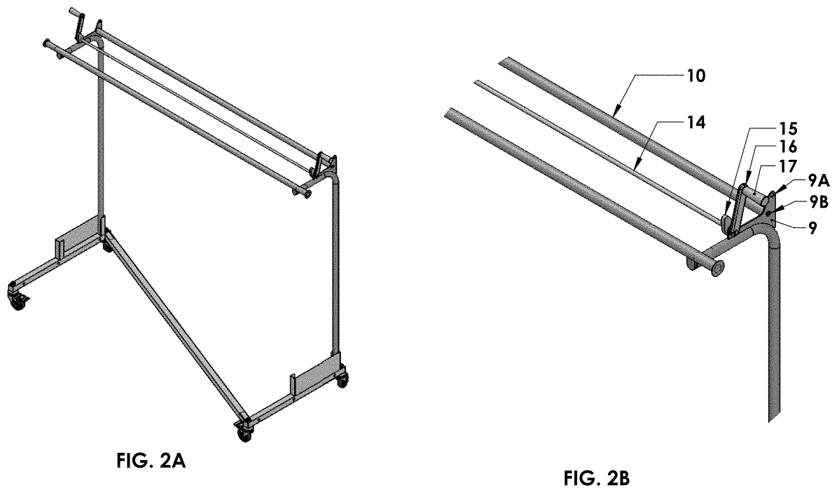

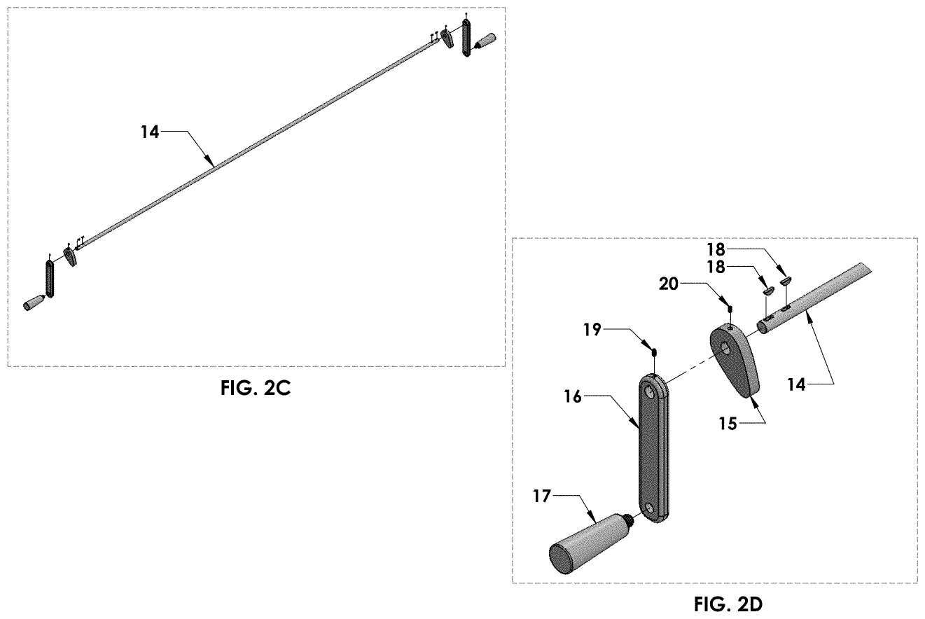

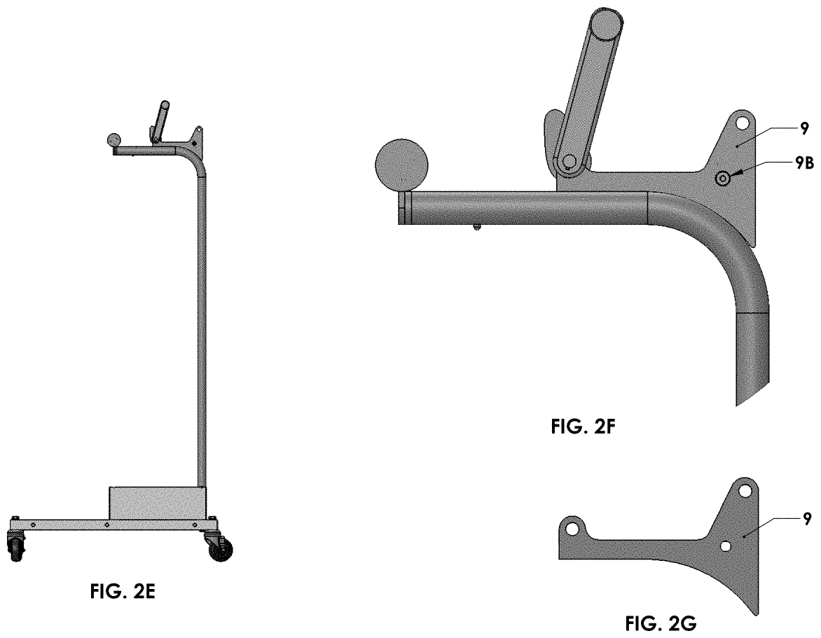

FIG. 2A presents a portion of the EzSort system having a storage member, a separator bar or separator for short, axle, and lever assembly attached to a mounting bracket whereby the EzSort housing (not shown) separator flanges may be moved atop the storage bar and moved away therefrom depending upon user actuation of the lever assembly in an embodiment disclosed herein. The separator 10 has two ends one is attached to a first rear portion of a bracket 9 and the other end is attached to a second bracket 9 rear end through welding or bolting thereon. The brackets 9 themselves are attached by welding at a bottom portion thereof, a first bracket 9 to a first horizontal portion of a first rail 5 and the second bracket 9 to a second horizontal portion of a second rail 5.

A first lever assembly and first end of axle 14 are movably attached to a first forward portion of a first bracket 9 and a second lever assembly and second end of axle 14 are movably attached to a second forward portion of a second bracket 9. Thus, the motion up and down of the EzSort module housing is actuated by the user interacting with a lever assembly to effect an UP or DOWN motion. This so as to position the flanges to remove clothing by sliding horizontally to another device that are already sorted or ready for removal within the downwardly disposed flanges of the EzSort housing (UP); thus, a user needs to move UP the flanges away from the storage member to permit the removal of clothing. Otherwise, a user begins a sorting process of the various items of all the assembly location hangers (DOWN) using the downwardly disposed flanges of the EzSort housing as they abut the storage bar; thus, the user positions the flanges atop the storage member so that each space between adjacent dual flanges forms a unique position for clothing that is marked by the LEDs buttons and or labels above.

FIG. 2B presents a closeup perspective view of the axle, bracket, lever assembly, separator, and storage member such that the lever assembly is movably attached to a bracket and a portion of an EzSort system in an embodiment disclosed herein. The lever assembly primarily comprises a cam 15, a handle lift 16 or lift for short, a handle 17; these interact with the bracket 9 and axle 14 to lift a housing support member 21 integrally attached to the EzSort housing by rotation of cam 15. Pin 9A is for attachment of housing support member 21 using a hole at top end of bracket 9 Connection point 9B is for use with nut plate 13 as there is an insertion of a bolt through bracket 9 at connection point 9B hole for further entry into a hole of the nut plate 13 of separator 10. This connection point 9B is typically a screw or bolt inserted within a hole of the bracket 9 that further is inserted within a threaded cavity in one of the nut plates 13 (FIG. 1E) thereby fixing the separator 10 to the bracket; a C clip is optionally useable to lock a depression on the screw or bolt therewith. The other side of the separator 10 is similarly attached to the other bracket 9 using another threaded nut plate in the other end with another screw (bolt) affixing it thereto.

FIG. 2C presents an assembly view of the axle 14 in association with various components of the lever assembly at either end thereof.

FIG. 2D presents a closeup assembly view of the axle and lever assembly in an embodiment disclosed herein. The following discussion applies to both lever assemblies that include cam 15, handle lift 16, handle 17 and further includes woodruff keys 18, and axle 14, (cup point set) screw 19 (cup point set) screw 20; these are applicable to either lever assembly on either the right side or left side of axle 14 as it interacts with the axle 14 using woodruff keys 18 and bracket 9 as a support. The handle 17 has a threaded end which is screwed into a corresponding threaded cavity in handle lift 16 for tight association therewith. The handle lift 16 has a first hole at an end opposite the threaded cavity for insertion of an end of axle 14. Also, the cam 15 has a second hole for the axle 14. An end of axle 14 has a dual set of notches 18 within close proximity of one another; these notches are used for the insertion of two woodruff keys one to each notch.

The axle 14 is first inserted within cam 15 through the second hole therein and on into a third hole in bracket 9 finally inserting the end of axle 14 into the first hole in handle lift 16. As the axle 14 is inserted into the second hole of cam 15 and on into the first hole of handle lift 16 one woodruff key locks the cam 15 and the other locks the handle lift 16 into rotation synchronicity with the axle 14 and each other. In other words the cam 15, the handle lift 16, handle 17 move together as a single unit with the axle 14 which rotates within the third hole of the bracket 9 acting as a support therefore. First (cup point set) screw 19 entering into a first orifice in the handle lift 16 presses against a first woodruff key to lock it into place and a second (cup point set) screw 20 entering into a second orifice in the cam 15 presses against a second woodruff key 18 to lock it into place. Thus, the cam 15, handle lift 16 and handle 17 are locked into coordinated motion as previously described.

Thus, this closeup shows how the axle 14, one lever assembly (cam 15, handle lift 16, handle 17), bracket 9 (not shown, understood between lift 16 and cam 15), woodruff keys 18 and set screws 19, 20 in an embodiment disclosed herein. Handle lift 16 and cam 15 each have an orifice within a narrow perimeter surface thereof. These orifices are for the insertion of a single set screw 19, 20 therein. First (cup point set) screw 19 entering into a first orifice in the handle lift 16 presses against a first woodruff key 18 to lock it into place; and a second (cup point set) screw 20 entering into a second orifice in the cam 15 presses against a second woodruff key 18 to lock it into place. Thus, the cam 15, handle lift 16 and handle 17 are locked into coordinated motion as previously described.

FIG. 2E presents a side view of a portion of the EzSort system in an embodiment disclosed herein.

FIG. 2F presents a closeup side view of the top of a rail with a bracket attached thereto and a lever assembly movable attached to a rail in the EzSort system in an embodiment disclosed herein. The bracket 9 has a bottom contour that curves as does the top of the rail that it is attached to with bolt-nut and or welding. Also, shown are a handle, lift, cam and storage member and a connection point 9B for separator 10; this connection point 9B is typically a screw or bolt inserted within a hole (below the hole for housing support member 21 and midway to bottom triangular portion) of the bracket 9 that further is inserted within a threaded cavity in one of the nut plates 13 (FIG. 1E) thereby fixing the separator 10 to the bracket; a C clip is optionally useable to lock a depression on the screw or bolt therewith. The other side of the separator 10 is similarly attached to the other bracket 9 using another threaded nut plate in the other end with another screw (bolt) affixing it thereto.

FIG. 2G presents a closeup side view of a bracket in an embodiment disclosed herein. The bracket has a longitudinal portion having a bottom edge contoured to the top of a corresponding rail. A left (forward) portion (to the left in the figure) of the bracket has a small raised portion that has a hole for the insertion of an axle 14 therethrough within which the axle 14 will rotate. The rear part of the bracket has top portion that is triangular in shape having a hole at top to be an attachment point for support member 21 thereby acting as a hinge hole for insertion of a hinge pin therein as described below. The right (rear) bottom portion of bracket 9 is also triangularly shaped whose bottom portion also follows the curve of the rail to which it will be attached.

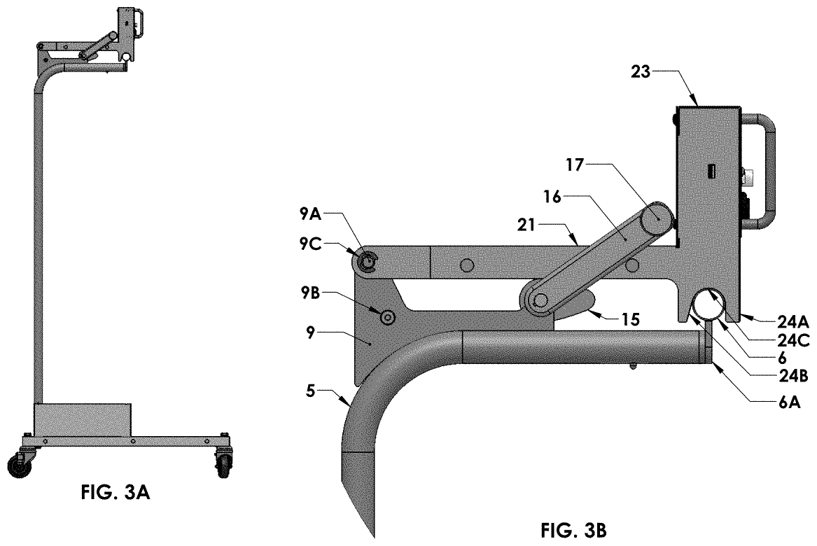

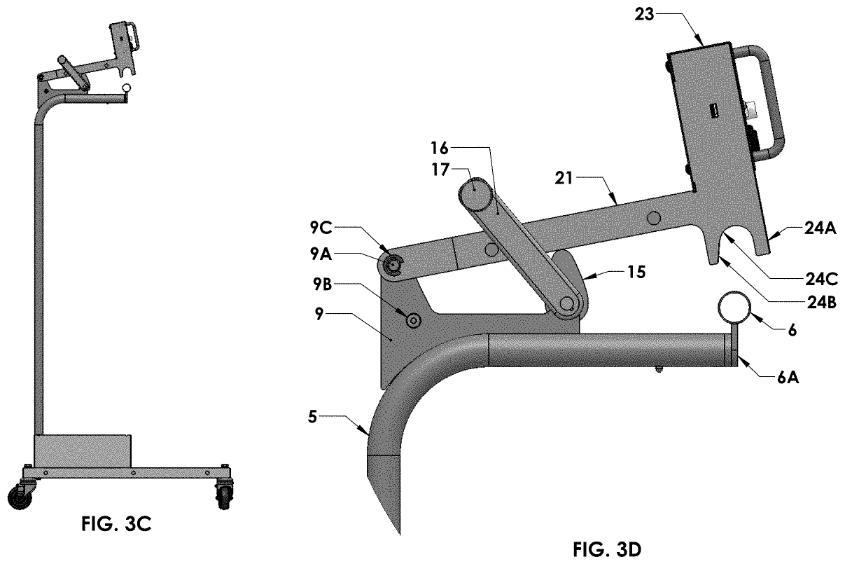

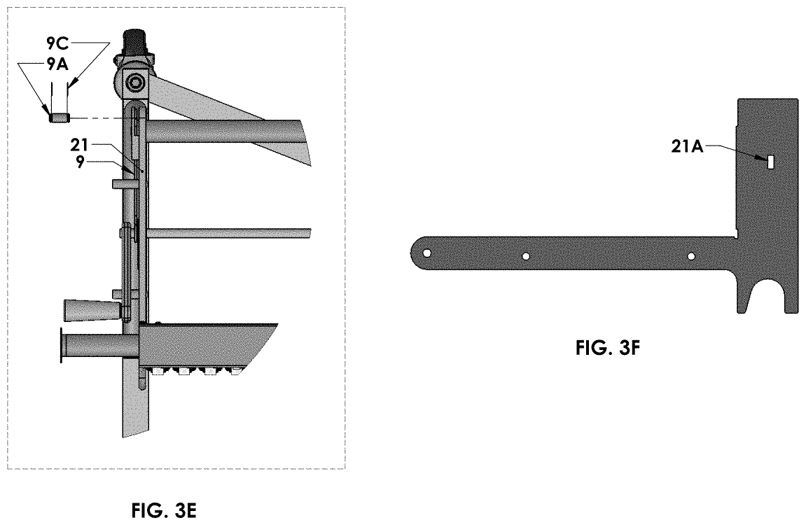

FIG. 3A presents an opposite side view of that of FIG. 2E illustrating the Housing DOWN Position showing an EzSort housing associated with its housing support member through hinge pin attachment to a bracket; also, a lever assembly is movably attached to the bracket for motion of the EzSort Up and Down. The bracket is attached to a rack rail, Z bar and casters in an embodiment disclosed herein of an EzSort System.

FIG. 3B presents a closeup opposite side view (of that of FIG. 2E) of the EzSort housing 23 having its divider flanges abutting a clothing bar in the Housing DOWN position; the EzSort housing 23 is movably attached to bracket 9 through a housing support member 21 attached to the outside of the EzSort housing; also, a lever assembly is movably attached to the bracket in an embodiment disclosed herein. The discussion of this figure applies to both brackets 9 and two lever assemblies shown on opposite sides of the EzSort in FIG. 2A, 2C and to two housing support members 21 associated therewith on opposite sides of the housing 23 for cooperative hand motion of the EzSort for user actuation therewith.

An EzSort housing is a six sided oblong box having four longitudinal sides and two smaller end sides that are combined appropriately along corresponding edges. Within the EzSort housing are mounts for button, buttons inserted within those aforementioned mounts, LED mounts and LED's mounted within the LED mounts and openings in the housing for buttons and LEDs to protrude as appropriate. There are also electronic mounts formed therein for circuit boards, circuits, power supply, power conversion and or wiring necessary through opening(s) or hole(s) in the housing 23 to a power outlet not shown; this thereby powers the LEDs, button, circuit boards and so forth.

The housing support member 21 is formed generally in a T shape or hammer shape having a handle and a head. The housing support member 21 has a hole in its handle that is attached using a pin 9A (acting as a hinge) inserted within this hole and into another hole in the triangular upwards portion of a bracket 9. Then using two c-clips placed in a first and second circumferential notch on either side of the pin 9A movably locks the housing support member 21 in place; thus, one c-clip is on one side (far opposite side of the other clip) of the handle of housing support member 21 and one c-clip on the far opposite side of the bracket 9. Also, it should be understood that the housing 23 is attached to the housing support member 21 using welding and or screws mounted in holes in the top of the head of the housing support member 21 that engages other holes—nuts within housing or with other threaded holes in the housing or similar attachment mechanisms.

There is a set of dual flanges 24A, 24B integrally located at a bottom of the housing support member 21 head. These dual flanges 24A, 24B descend down and away from the housing 23 and and are designed to so that a curved cavity 24C exists between the dual flanges 24A, 24B for the abutting of the storage member 6 therein. It should be noted that cam 15 (oval, pear, elliptical, heart, elongated or similar) that is in lock step association with handle 17 and handle lift 16 through axle 14 is disposed so that one side surface of the cam 15 tightly abuts a bottom edge of the housing support member 21 handle; thus, when the handle 17 of the lever assembly is rotated this effects the turning of the cam 15 about axle 14 causing the housing support member 21 to move up or down by the corresponding action thereof.

Finally, the housing EzSort housing 23 has a plurality of sets of dual flanges 24A, 24B (also known as dividers herein) that are integrally formed, attached or welded to the bottom of the housing 23. These dual flanges 24A, 24B descend down and away from the housing 23 and and are designed to so that a curved cavity 24C exists between the dual flanges 24A, 24B for the abutting of the storage member 6 therein. The storage member 6 is attached to the top straight or linear portion of both rails 5 at an endpoint thereof using two vertical supports 6A; thus, one vertical support 6A is welded to the endpoint of rail 5 and the other vertical support 6A is welded to the endpoint of the other rail 5. These flanges can be thought of as a forward flange 24A (away from vertical portion of rail and closer to forward portion of EzSort housing 23 front surface with LEDs buttons) and rear flange 24B (towards rail vertical portion and farther from EzSort housing 23 front surface with LEDs buttons).

FIG. 3C presents a side view similar to FIG. 3A but having the Housing UP Position; here are shown an EzSort housing attached to a bracket through a housing support member and moved by a lever assembly attached to the bracket that in turn is attached to a rack rail in an embodiment disclosed herein.

FIG. 3D presents a closeup side view of FIG. 3C the EzSort housing having its (dividers) flanges 24A, 24B not abutting a clothing bar in the Housing UP position; the EzSort housing is attached to a bracket through a housing support member 21 whilst a lever assembly is also attached to the bracket that in turn is attached to an rack rail thereby showing the UP position in an EzSort system in an embodiment disclosed herein. As a user rotates the handle 17, this motion is translated through handle lift 16 and cam 15 using axle 14 acting within bracket 9. As a result, the oval (pear, heart, elliptical, or other type) shaped cam rotates thereby providing a greater vertical height that is expressed by pushing a bottom surface of the housing support member 21 upwards. Of course, this has the intended effect of moving the housing support member 21, the housing 23, flanges 24A-B and so forth upwards. In this fashion, a user can remove any and all assembly location (hangers) by sliding them off the storage member 6 onto another rack as described more fully below.

FIG. 3E present a closeup top assembly view of a portion of the EzSort system in an embodiment disclosed herein. Pin 9A (hinge) is shown in the drawing for insertion in bracket 9 and on into housing support member 21 to movably connect these two using c-clips 9C; these c-clips are inserted in notches near either end of the Pin 9A one on the far side of the housing support member 21 and the other on the opposite far side of the bracket. Thus, the end portion of the handle having a hole of each housing support member 21 is situated near the inside of its respective bracket 9 (triangular top portion of FIG. 2G at right side of figure having hole) when viewed from the longitudinal center of the EzSort system.

FIG. 3F presents an opposite side view of a housing support member in an embodiment disclosed herein. The housing support member 21 has a handle and a head in a T shape of hammer. The handle has a hole near an end thereof for attachment of pin 9A to bracket 9 using c-clips 9C. A hole 21A is an opening for a USB port communicating to internal circuit boards, electronics and so forth in the EzSort housing. Thus, there is a USB port mounted on a board or appropriate mounting device within the EzSort housing 23.

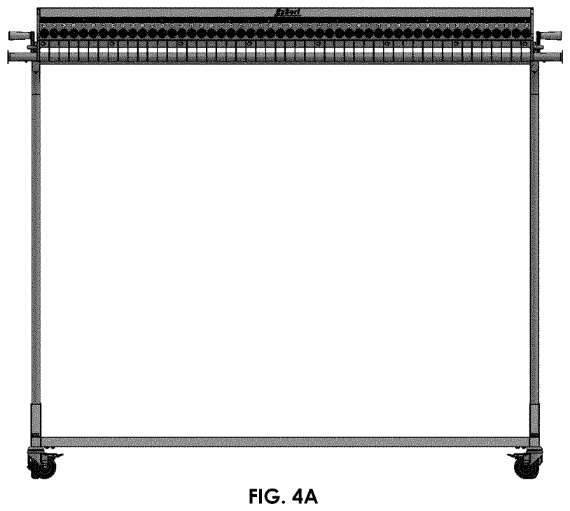

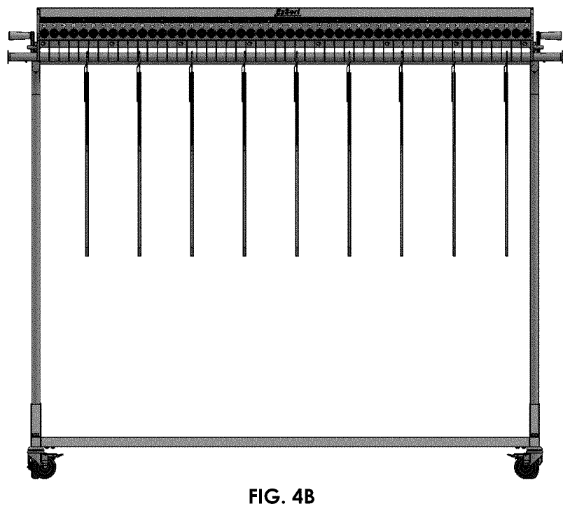

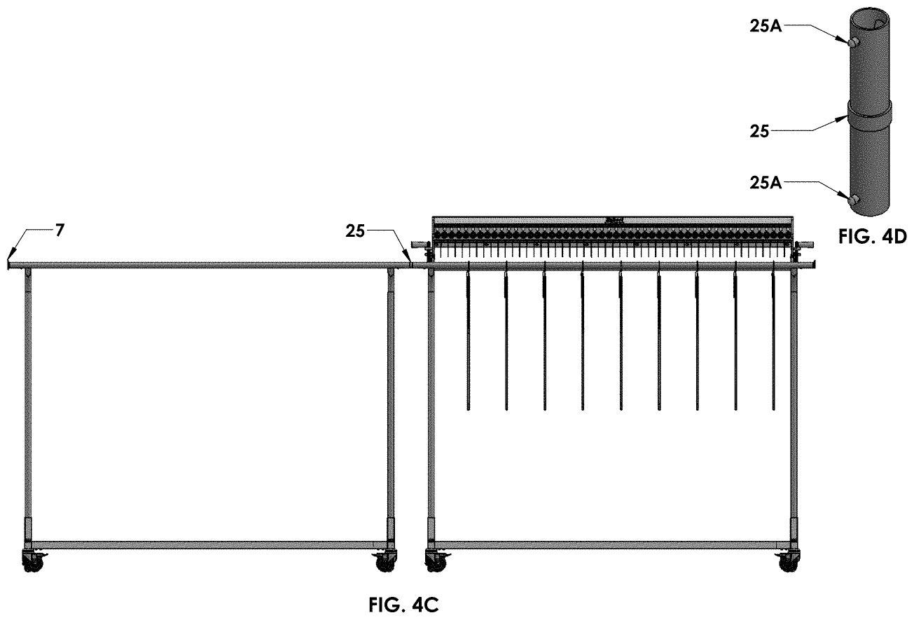

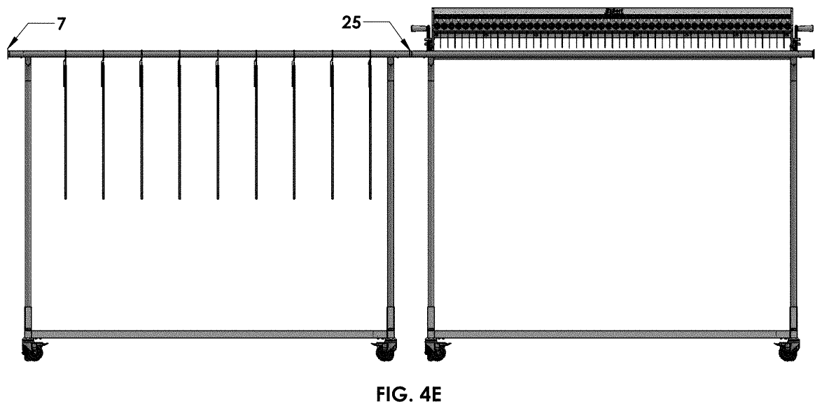

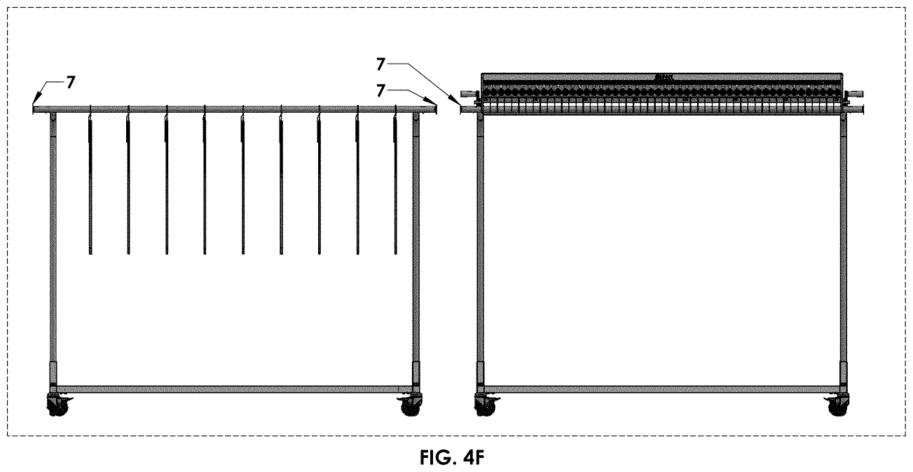

FIG. 4A presents a front view of an empty EzSort System in an embodiment disclosed herein.

FIG. 4B presents a front view of a partially loaded EzSort System in an embodiment disclosed herein showing assembly locations (hangers) on the storage member of the EzSort with clothing thereon.

FIG. 4C presents a front view of a partially loaded EzSort System ready to transfer textiles and or clothing to an EzBar through a temporary coupling in an embodiment disclosed herein. Here the EzBar has an end cap 7 on the left side which is essentially a tube having a larger circular flange that prevents clothing from sliding off; this end cap 7 is inserted within an end cavity in the storage bar of the EzBar. On the right side of the EzBar there is a short temporary coupling 25 which is a tube or rod having similar external diameter size (along portions of its length) as the inside diameter of the storage member or storage bar of the EzBar and of the EzSort system; this so the short temporary coupling is inserted one end into the EzBar storage member and the other end into the storage member of the EzSort system.

FIG. 4D presents a rotated front view of the coupling used to temporarily connect an EzBar to an EzSort system or to connect several EzSorts together or to connect several EzBars together in an embodiment disclosed herein. The coupling 25 formed as a tube or rod has a central portion that is wider than a first and second end thereof. Within an appropriate space or cavity within the first and second end are found a snap button 25A (one to each end) placed within the aforementioned space or cavity. These are held in place by welding, brazing, or being situated within a depression form fitted to hold the snap buttons 25A in place. One hole is found in the first end and a second hole at the second end permits the head of the snap buttons 25A to exit therefrom for appropriate user interaction. The first snap button 25A is used to attached to an EzSort system or EzBar at an appropriate hole within the storage bar thereof. Another EzSort system or EzBar comes equipped with a hole in their storage bar for insertion of the other one of the snap button 25A heads therethrough thereby engaging the two together.

FIG. 4E presents a front view of an empty EzSort System after having transferred textiles and or clothing to a now partially loaded EzBar through a temporary coupling in an embodiment disclosed herein. A user has moved the clothing or textiles on hangers over to the EzBar from the EzSort System using the temporary coupling 25.

FIG. 4F presents a front view of an empty EzSort System after having transferred textiles and or clothing to an EzBar and after having decoupled from the EzBar in an embodiment disclosed herein. A second end cap 7 is introduced into the EzBar at the right side of the storage bar and an end cap 7 is introduced into the left side of the EzSort System to avoid materials falling off (and to its right side if it was not there already).

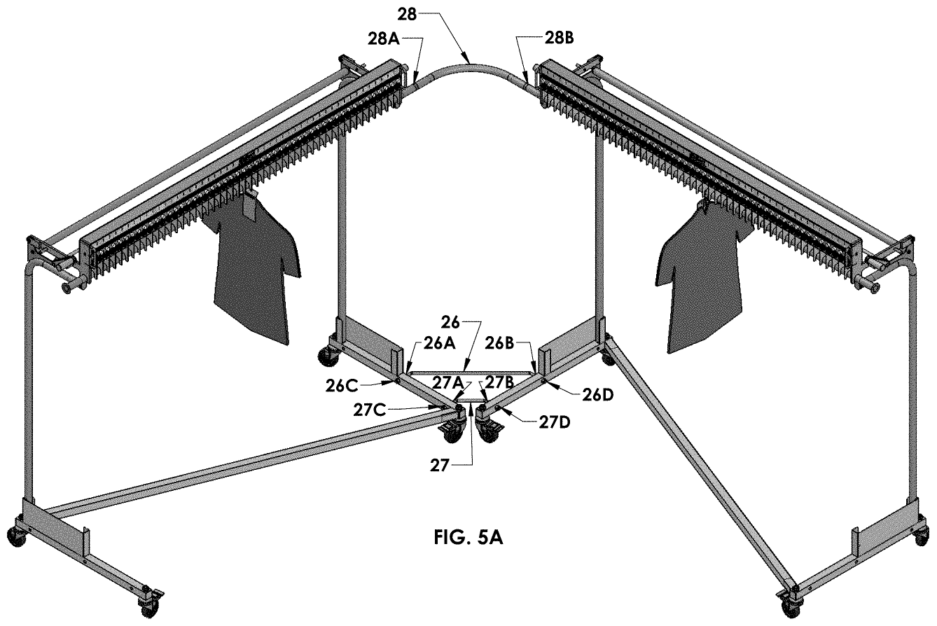

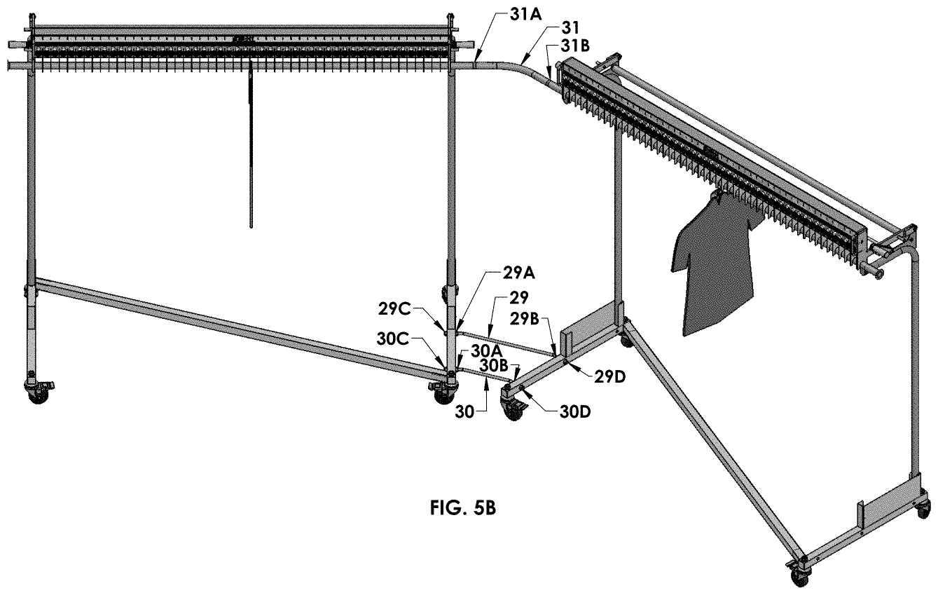

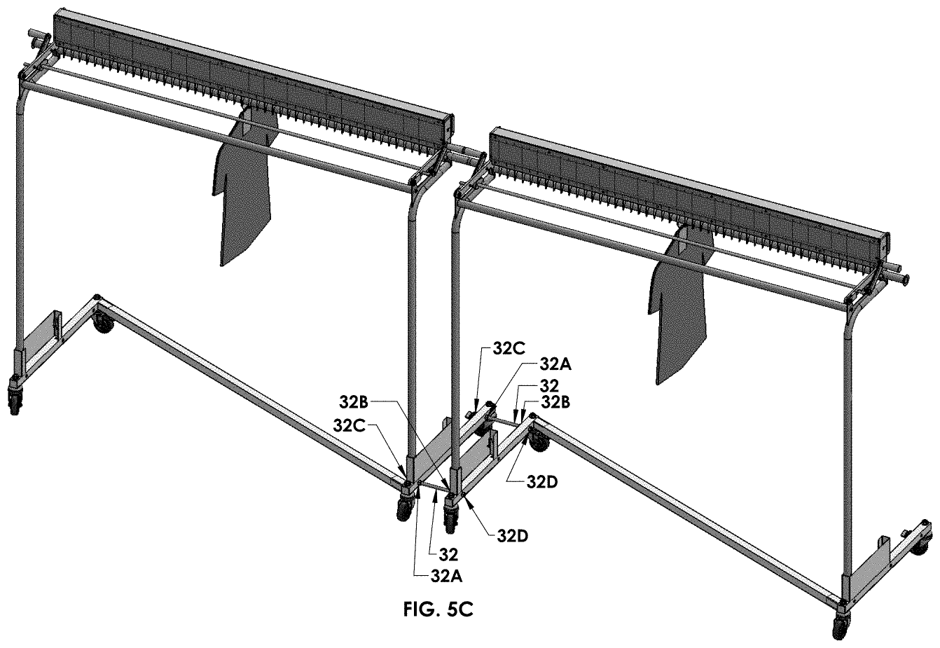

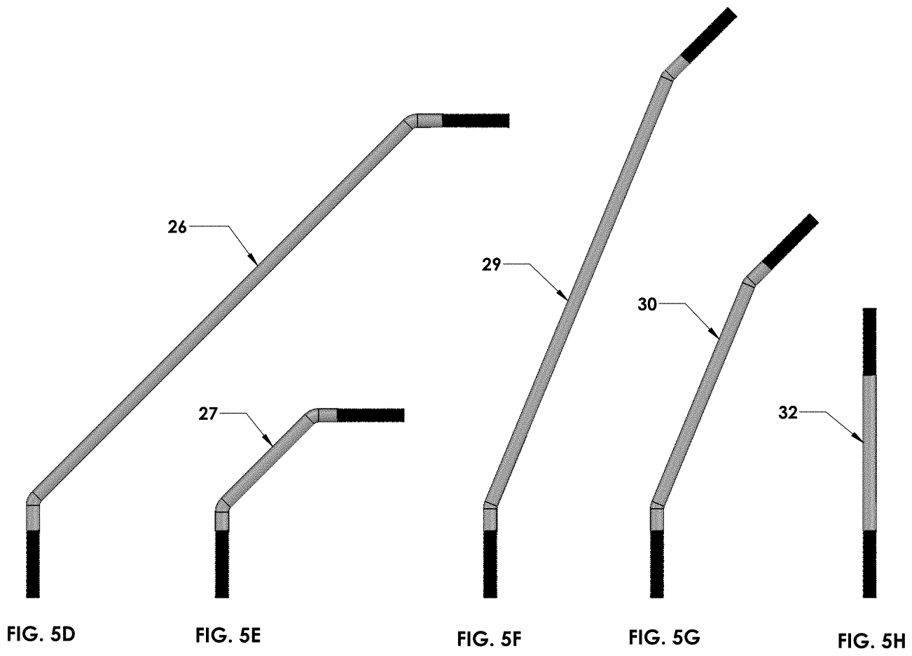

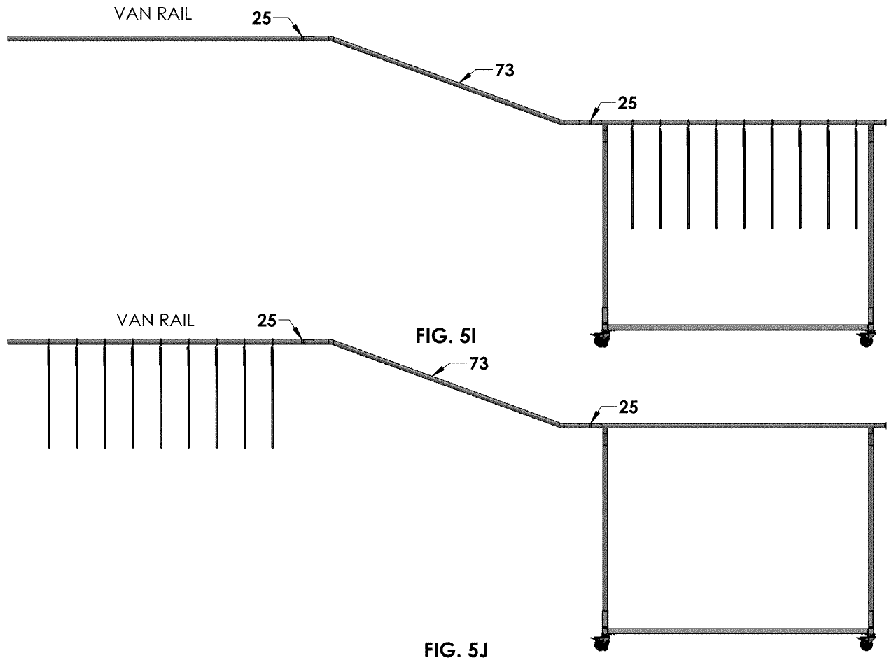

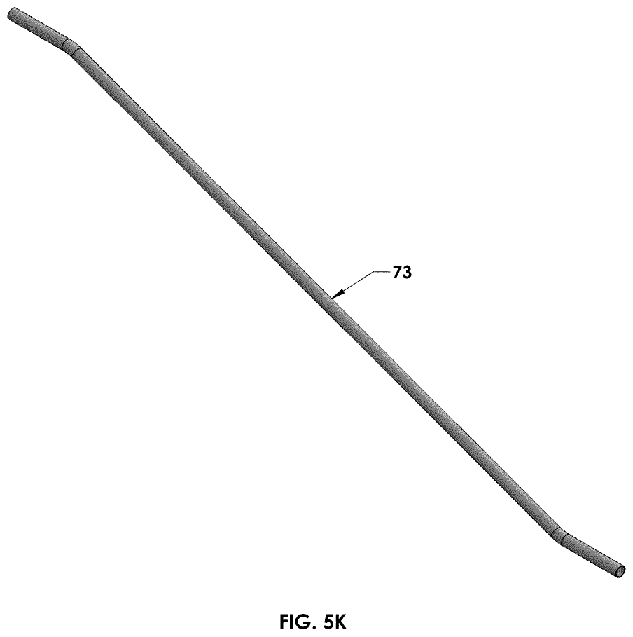

FIG. 5A presents an extended system whereby multiple EzSort Systems are connected together in a first connection alternative embodiment disclosed herein. Here there are two EzSort systems connected together in an L shape or 90 degree implementation. The first and second are connected with an integral connector 28 formed as a curved bar or cylinder having two ends at right angles to one another and a center curved portion that smoothly shapes a right angle between the storage members (and the two ends of the connector 28) of the first and second systems. These are inserted within the storage members thereof and as with the previous descriptions locked together using snap buttons 28A, 28B that has been situated within the connector (welded, placed in a notch or space to hold in place within a cavity at either end of the connector) 28 and has its snap button heads protruding out of holes in its surface at either end of the connector 28 that engage holes in the storage members of the connected systems.

There are two floor bars between the first and second EzSort systems; these are a long bar 26 and a short bar 27. All connections of the following long and short bars is by hex nut connections as the long and short bars are placed in appropriate holes of the EzSort System floor Z bars. The long 26 and short bar 27 each have two angled ends having threads thereon facilitating the attachment of hex nuts thereto.

The short bar 27 is attached to the upper leg of the left Z figure near one upper right diagonal point of the Z bar (top right of Z figure of first left system); and on the other side it is connected to the upper leg of the right Z figure near the upper left endpoint of the Z bar (top left of Z figure in the second EzSort system). To accomplish this, there are two pre-fastened hex nuts 27A, 27B attached to two threaded bent ends of short bar 27. These are situated on those threads so as to prevent the bar 27 from sliding further inwards towards the left system (hex nut 27A) when it enters a first hole or right system (hex nut 27B) when it enters a second hole thereby destabilizing the connected systems thereby.

As the short bar 27 first threaded end exits a first hole in the upper leg of the left system it is locked in position by a hex nut 27C thereby preventing the bar 27 from sliding back outwards therefrom which would destabilize the connected systems. Similarly, as the short bar 27 second threaded end exits a second hole in the upper leg of the right system it is locked in position by a hex nut 27D thereby preventing the bar 27 from sliding back outwards therefrom which would destabilize the connected systems.

The long bar 26 is attached to the upper leg of the left Z figure near a midpoint thereof (of first left system); and on the other side it is connected to the upper leg of the right Z figure near a midpoint thereof (second EzSort right system). To accomplish this, there are two pre-fastened hex nuts 26A, 26B attached to two threaded bent ends of long bar 26. These are situated on those threads so as to prevent the bar 26 from sliding further inwards towards the left system (hex nut 26A) when it enters a third hole or right system (hex nut 26B) when it enters a fourth hole thereby destabilizing the connected systems thereby.

As the long bar 26 first threaded end exits a third hole in the upper leg of the left system it is locked in position by a hex nut 26C thereby preventing the bar 26 from sliding back outwards therefrom which would destabilize the connected systems. Similarly, as the long bar 26 second threaded end exits a fourth hole in the upper leg of the right system it is locked in position by a hex nut 26D thereby preventing the bar 26 from sliding back outwards therefrom which would destabilize the connected systems.

FIG. 5B presents another extended system whereby multiple EzSort Systems are connected together in a second connection alternative (oblique angle connection) embodiment disclosed herein. Here there are two EzSort systems arranged together such that the first and second systems have an oblique angle connector 31 formed as a tube or cylinder inserted between the storage members of the aforementioned. As with the previous descriptions the EzSort systems, these are locked together using connector 31 snap buttons 31A, 31B that has been situated therein (welded, placed in a notch or space to hold in place within a cavity at either end of the connector); this using snap button heads protruding out of holes in its surface at either end of the connector 31 that engage holes in the storage members of the connected systems.

All connections of the following long and short bars is by bolt-hex nut connections in appropriate holes of the EzSort System floor Z bars and appropriate holes in the long and short bars. Also, the first and the second systems have an oblique long bar 29 and an oblique short bar 30 connected there between using appropriate holes in two legs one from each of the EzSort systems; in this case, the right leg of the left system and the top leg of the right system where these are situated at the midpoint of the figure. The oblique long bar 29 and oblique short bar 30 each have two angled ends having threads thereon facilitating the attachment of hex nuts thereto.

The oblique short bar 30 is attached to the right leg of the left Z figure near one right diagonal point of the Z bar (first left system); and on the other side it is connected to the upper leg of the right Z figure near the upper left endpoint of the Z bar (top left of Z figure in the second EzSort system). To accomplish this there are two pre-fastened hex nuts 30A, 30B attached to two threaded bent ends of oblique short bar 30. These are situated on those threads so as to prevent the bar 30 from sliding further inwards towards the left system (hex nut 30A) when it enters a first hole or right system (hex nut 30B) when it enters a second hole thereby destabilizing the connected systems thereby.

As the oblique short bar 30 first threaded end exits a first hole in the right leg of the left system it is locked in position by a hex nut 30C thereby preventing the bar 30 from sliding back outwards therefrom which would destabilize the connected systems. Similarly, as the oblique short bar 30 second threaded end exits a second hole in the upper leg of the right system it is locked in position by a hex nut 30D thereby preventing the bar 30 from sliding back outwards therefrom which would destabilize the connected systems.

The oblique long bar 29 is attached to the right leg of the left Z figure near a midpoint thereof (of first left system); and on the other side it is connected to the upper leg of the right Z figure near a midpoint thereof (second EzSort right system). To accomplish this, there are two pre-fastened hex nuts 29A, 29B attached to two threaded bent ends of oblique long bar 29. These are situated on those threads so as to prevent the bar 29 from sliding further inwards towards the left system (hex nut 29A) when it enters a third hole therein or right system (hex nut 29B) when it enters a fourth hole therein thereby destabilizing the connected systems thereby.

As the oblique long bar 29 first threaded end exits a third hole in the right leg of the left system it is locked in position by a hex nut 29C thereby preventing the bar 29 from sliding back outwards therefrom which would destabilize the connected systems. Similarly, as the oblique long bar 29 second threaded end exits a fourth hole in the upper leg of the right system it is locked in position by a hex nut 29D thereby preventing the bar 29 from sliding back outwards therefrom which would destabilize the connected systems.

FIG. 5C presents another extended system whereby multiple EzSort Systems are connected together in a third connection alternative embodiment disclosed herein. Two EzSort Systems have two floor bars 32 having two threaded ends of identical or similar size connecting the two system together. All connections of the following floor bars is by bolt-hex nut connections in appropriate holes of the EzSort System floor Z bars and appropriate holes in the floor bars. A first bar 32 is connected to the first left system right leg near its right diagonal endpoint and connected to the second right system left leg near its left endpoint of the Z in the second system. The second bar 32 is connected to the right leg near to the right endpoint of the Z bar of the first left system and connected to the left leg near the left diagonal endpoint of the second Z bar of the second right system. It should be understood that there are two floor bars 32 and that the connection modality is duplicated in third and fourth holes as described above and below using pre-fastened hex nuts and other hex nuts.

A coupling 25 is inserted between the storage members of the two systems as shown in FIG. 4D using holes in the storage members of the systems to accept the heads of the snap buttons within the coupling 25 ends that protrude out of surface holes in the coupling 25 ends.

To accomplish this interconnection there are two pre-fastened hex nuts 32A and 32B attached one to each threaded end of the bar 32 so that upon insertion of the first threaded end of bar 32 into a first (or third) hole of the right leg of the first system and the second threaded end of bar 32 into a second (or fourth) hole of left leg of the second system they can not slide further inwards into either system. These are situated on those threads so as to prevent the bars 32 from sliding further inwards towards the left system (hex nut 32A) when it enters a first (or third) hole or right system (hex nut 32B) when it enters a second hole (or fourth) thereby destabilizing the connected systems thereby.

As the floor bars 32 first threaded ends exit a first hole (or third) in the right leg of the left system it is locked in position by a hex nut 32C thereby preventing the bar 32 from sliding back outwards therefrom which would destabilize the connected systems. Similarly, as the floor bars 32 second threaded end exits a second hole (or fourth) in the left leg of the right system it is locked in position by a hex nut 32D thereby preventing the bars 32 from sliding back outwards therefrom which would destabilize the connected systems.

FIG. 5D presents a long floor bar 26 having two threaded ends disposed at separate 45 degree angles to the central integral portion of the floor bar 26 thereby forming a ninety degree angle between the two threaded ends; the angles could be modified as desired in an embodiment disclosed herein.

FIG. 5E presents a short floor bar 27 having two threaded ends disposed at separate 45 degree angles to the central integral portion of the short floor bar 27 thereby forming a ninety degree angle between the two threaded ends; the angles could be modified as desired in an embodiment disclosed herein.

FIG. 5F presents an oblique long floor bar 29 having two threaded ends disposed at separate oblique angles to the central integral portion of the long floor bar 29 thereby making an oblique degree system; the angles could be modified as desired in an embodiment disclosed herein.

FIG. 5G presents an oblique short floor bar 30 having two threaded ends disposed at separate oblique angles to the central integral portion of short floor bar 30 thereby making an oblique degree system; the angles could be modified as desired in an embodiment disclosed herein.

FIG. 5H presents a floor bar 32 having two threaded ends disposed linearly with a central integral portion thereof to make a linear system in an embodiment disclosed herein.

FIG. 5I presents an EzBar having clothes mounted on its storage member using assembly locations (hangers) attached to a van rail an embodiment disclosed herein. An EzBar connected to a van rail prior to transferring textiles through a temporary transfer bar (EzTransfer Bar). The EzTransfer bar has two integral bent ends opposite one another that couple as follows; at a first bent end thereof to a first end of a first one of two connectors 25 having snap buttons, and the second bent end of the EzTransfer bar to a first end of the second one of two connectors 25. The other end of a first connector 25 attaches to a van rail and the other end of the second connector 25 attaches to an EzBar. The EzTransfer bar has no snap button holes or snap buttons allowing it to rotate freely for freedom of motion. Permits transfer of clothes from ground up to a van position.

FIG. 5J presents an EzBar after having clothes transferred from its storage member using assembly locations (hangers) to a van having an attached van rail an embodiment disclosed herein. An EzBar connected to a van rail after transferring textiles through a temporary transfer bar (EzTransfer Bar). The EzTransfer bar has two bent ends that couple at either end with two connectors 25 having snap buttons. The other end of a first connector 25 attaches to a van rail and the other end of the second connector 25 attaches to an EzBar. The EzTransfer bar has no snap button holes or snap buttons allowing it to rotate freely for freedom of motion. Can also be used to transfer to ground based EzSort.

FIG. 5K presents a closeup view of EzTransfer Bar 73. The EzTransfer bar 73 is made from a hollow metal component. It has two ends bent at similar angles with the angles disposed in opposite fashion at either end in order to easily transfer items to higher or lower vehicles or moving equipment. The EzTransfer bar has two bent ends that couple at either end with two connectors 25 having snap buttons. The other end of a first connector 25 attaches to a van rail and the other end of the second connector 25 attaches to an EzBar. The EzTransfer bar has no snap button holes or snap buttons allowing it to rotate freely for freedom of motion.

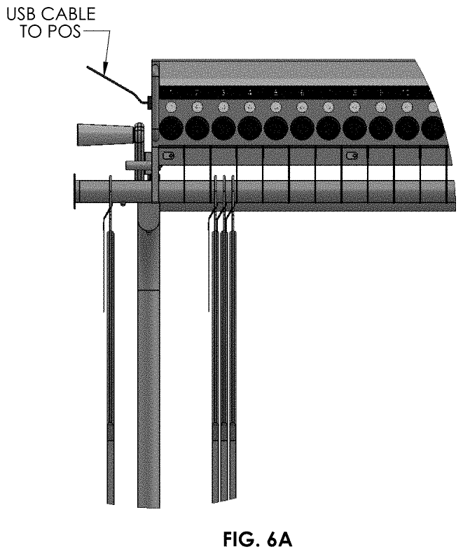

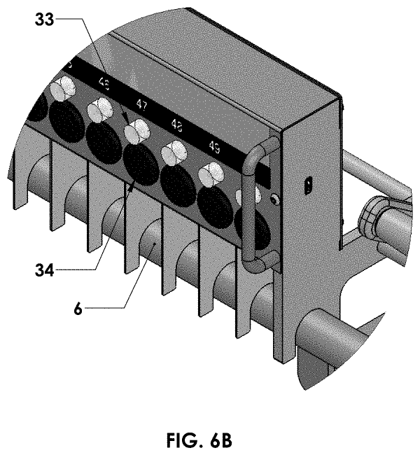

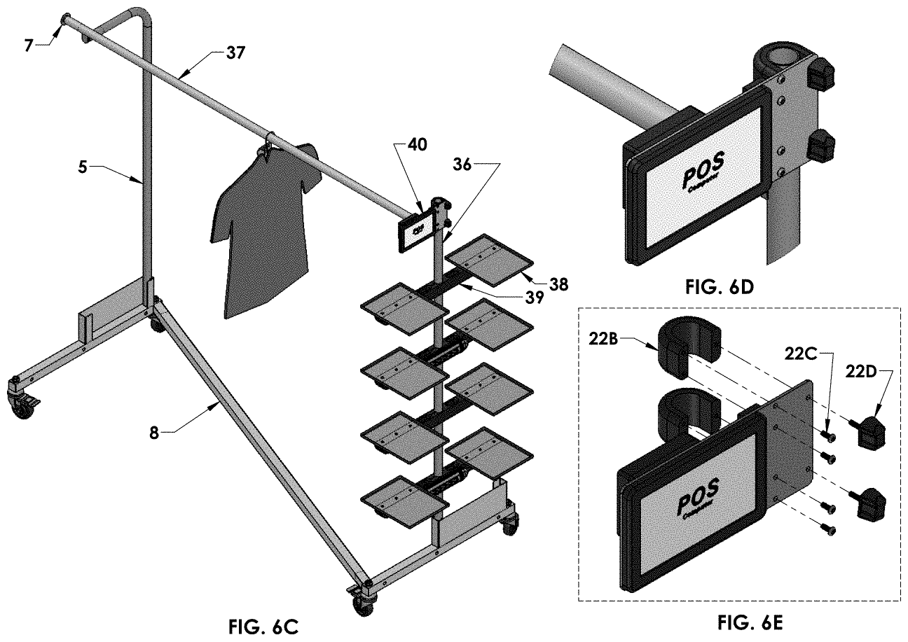

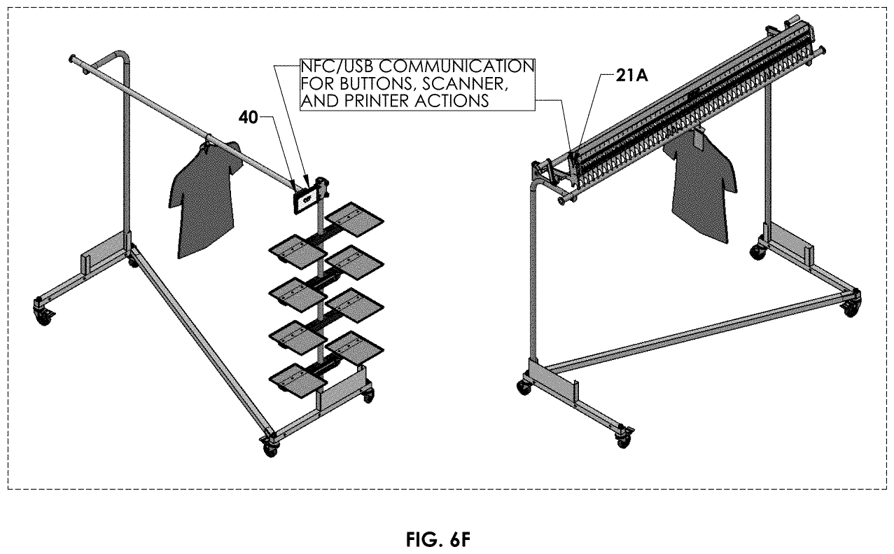

FIG. 6A presents a closeup of various LEDs and buttons on the EZSort housing.

FIG. 6B presents a closeup view of a front panel of the EzSort system housing having a group of numerical location indicators, a set of LEDs and a set of push buttons so that each one of the set of LEDs is associated with a single numerical location indicator and a single push button in an embodiment disclosed herein. Here a set of LEDs indicated by 33 are loaded into appropriately molded mounts within the EzSort housing 23 and exit out holes of EzSort housing 23 that thereby permit them to protrude out therefrom. Underneath these are push buttons 34 similarly loaded into appropriately molded mounts within the EzSort housing 23 and exit out holes of EzSort housing 23 that thereby permit them to protrude out therefrom. Also, shown in the figure are a row of forward flanges 24A extending out from the bottom of an EzSort housing that abuts about a storage member 6 of an EzSort system.

FIG. 6C presents a modified EzBar formed as an equipment storage system in an alternative embodiment disclosed herein. Here a typical EzBar system described with respect to FIG. 1B has been changed to store various items. As before, a Z bar 8 forms the floor base. It has a first rail 5 attached similarly on the upper leg of the ‘Z’ (not diagonal) of the Z bar with a support member from the upper leg of Z bar to rail 5. On the other lower leg (not diagonal) of the ‘Z’ of the Z bar is found a vertical rail 36 attached thereto all by welding or bolt-nut combination to a center point of the leg. A support member is also welded or bolted on to the Z bar lower leg and about the vertical rail 36 to provide extra support thereto. The top portion of bowed rail 5 and the vertical rail 36 are connected together using a storage member 37 that has been welded or bolted on top end of rail 5 to the vertical rail 36 near its top thereof. A computer 40 such as a POS point of sale computer has been attached to the top of the vertical rail 36.

A group of four mounts 39 are each formed as a single bar or piece of material that is horizontally welded or bolted (screw, nut similar modalities) on to the vertical rail 36 at appropriate distances from one another. The mounts 39 thereby spaced apart individually upon the vertical rail 36 form a support for a set of four dual stands formed as a first and second stands that are connected to the mount 39 using welding or bolt-nut combos. The stands 38 are flat sheets of material such as aluminum or stainless steel and are designed to support items such as printers, computer terminals, POS devices, InfraRed Scanners, label makers and similar items.

FIG. 6D presents a computer such as a POS point of sale computer that has been attached to the top of the vertical rail 36 in an embodiment disclosed herein.

FIG. 6E presents an exploded assembly view of how the POS point of sale computer has been attached to the top of the vertical rail in in an embodiment disclosed herein. Here a POS computer 40 has a short sheet of connecting material that has been attached thereto by welding, adhesive, bolt-nut or simple plastic tongue and groove locking there between. This sheet is in turn attached to two U shaped couplers 22B using four screws 22C that enter the sheet at four left holes therein and engage the couplers 22B two to a coupler 22B at appropriate holes therein. Further, there are two knobs 22D each having a threaded screw portion integrally formed therewith forming a connecting portion thereof; these threaded screws of knobs 22D are placed within appropriate holes of sheet and on into right holes of the couplers 22B whose inner space of the U shape surrounds the curve of the vertical rail 36. The loosening or tightening of these knobs facilitates the rotation of the POS computer 40 thereabouts to appropriately position it for use.

FIG. 6F presents how NFC/USB communication between a modified EzBar equipment storage and the EzSort system for button, scanner and printer actions in an embodiment disclosed herein. Here a POS computer 40 on the modified EzBar communicates using NFC, Bluetooth, USB, WIFI, Infrared or other type of communication to the EzSorting housing electronics of an EzSort system using USB 21A, wired or wireless communication such as antenna for infrared, WIFI, NFC and so forth. Thus, a user at one location can gather information about items being sorted on the EzSort system. For example, information passed between the two indicate to the user at POS computer 40 on the the status of buttons, LED lights and so forth, scanner and printer actions located on the EzBar stand positions.

Other Operational Details Other procedures operable under control of the computer software stored in memory of the touch screen computer system include the following:

If a garment is not placed within allotted time, the yellow LED will turn red, flash and beep. This error can be cleared by rescanning garment placing it in slot with yellow LED and pressing its associated black button promptly.

If an LED is flashing Green and a garment is not removed within allotted time, the associated LED will flash red and beep until garments are removed from its slot and its black button is pressed.

Once a slot is filled to capacity as specified by the EzSort system, the light will flash green. A user presses the black button and clothes are placed on the EzBar separated by invoice on first hanger. Optionally, a tie hanger group will twist tie machine.

The EzSort system has the ability to display the garment status on its associated computer touch screen by a user pressing the button above each slot. Slots containing garments for this order will light up white whilst missing garments will be displayed on screen (stragglers having stains, creases, missing buttons and so forth).

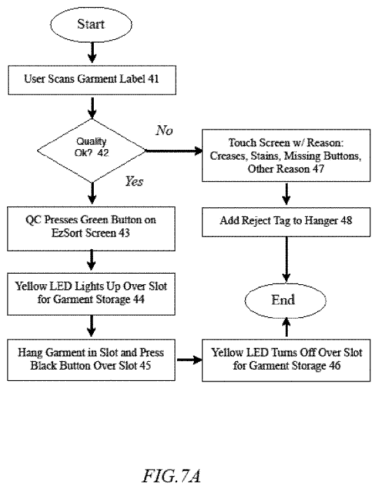

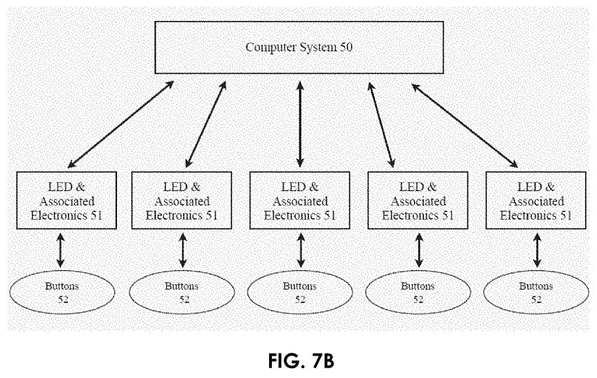

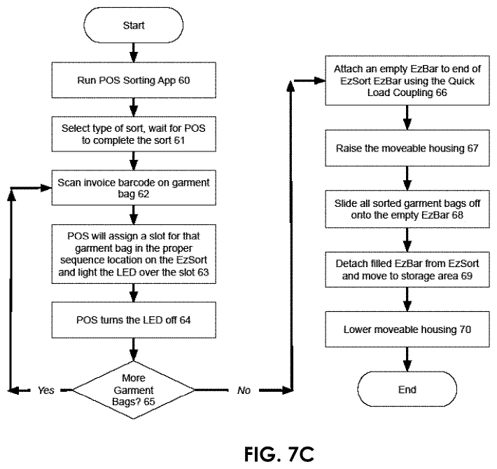

FIG. 7A presents a flowchart process of the loading of the EzSort system in an embodiment disclosed herein. A user has a hand held wand that can scan bar code labels using infrared electromagnetic radiation therefrom. It has been previously connected wirelessly (or wired) with the computer associated with the computer screen disclosed above. The user will scan a bar code label at step 41 and check at step 42 whether or not the garment finished appearance is acceptable. If acceptable, the quality control user presses a green button 43.

As a result, a yellow LED lights 44 up at the front of the EzSort module housing lighting up a slot for garment storage. This slot is between a pair of dual right and left flanges where each dual flange has a forward flange and a rear flange as discussed with respect to FIG. 3B items 24A, 24B. The user hangs the garment in the slot and presses 45 the black button on the front of the EzSort housing over the slot. As a result, the yellow light turns off over the garment storage 46 and process ends.

However, at step 42 in the event that the quality is not approved by the quality control user, thens he or she touches a Red Reject Button on the touch screen display. Another group of menu buttons appear describing various reasons for the rejection. The quality control user selects 47 one of those reasons and this is stored in an associated memory as appropriate. The reasons displayed are from a group comprising: creases, stains, missing buttons, other. Finally, a reject tag is added to the item on the hanger 48 for it to be re-cleaned, assembled or otherwise corrected according to the reason for the rejection stored in the computer memory associated with the EzSort and the process ends.

FIG. 7B shows an electronic circuit block diagram describing the various components in the EzSort system housed in the EzSort housing or attached thereto as described herein. A computer system 50 having a power supply, main computer processor board, nonvolatile and or volatile memory, video screen and all necessary electronics for a point of sale terminal is shown in the figure. These are in wireless or wired communication with a group of LEDs 51 mounted on the front surface of an EzSort housing and their associated electronics. Additionally, a bank of buttons 52 are loaded in the front surface of the EzSort module housing below a similarly mounted externally protruding group of LEDs having a numerical indication of each on the front surface thereof are also in communication with the POS computer.

FIG. 7C shows a flowchart method for sorting and assembling items prepared for delivery to a customer in an alternative embodiment disclosed herein. A user runs a POS sorting app at step 60 and selects 61 the type of sort and waits for the POS app to complete the sort. Then he or she scans an invoice barcode on a garment bag 62. As a result, the POS will assign a slot for that garment bag in the proper sequence location on the EzSort 63 and light the LED over the slot and user places garment bag at slot location. Next, the POS turns off 64 the LED.

At this point, a check is made as to whether there are more garment bags 65? If there are then the process proceeds to step 62 and cycles back to question step at 65. If there are no more garment bags, the process proceeds to step 66 where a user attaches an empty EzBar to an end of the EzSort where the EzBar uses the quick load coupling. The movable housing is raised at 67 and a user then slides all sorted garments onto the empty EzBar at 68. The filled EzBar is detached from the EzSort and moved to a storage area 69. Finally the movable housing is lowered at step 70.

The method has an inital step whereby the items are prepared for delivery to a customer wherein the movable housing is moved into a DOWN position and once prepared the movable housing is moved into an UP position for removal of order.

This method happens wherein said human sensible indicator is an addressable LED activated by a button. Here said addressable LED is addressable by said POS computer. The addressable LED is illuminated for a preset period of time to allow said operator to move said item to the associated location.

Finally, it should be understood that the wired communication comes with appropriate wire, addressing, busing, housing socket, power regulation and shaping to the various electronic components; similarly, the wireless communication comes with appropriate antenna, addressing, busing, power regulation and shaping to the various electronic components as is typically found in these arrangements.

The above-described embodiments are merely exemplary illustrations of various implementations set forth for a clear understanding of the principles of the invention. Many variations, combinations, modifications or equivalents may be substituted for elements thereof without departing from the spirit and scope of the invention. Therefore, it is intended that the invention not be limited to the particular embodiments as disclosed, but that the invention will include all the embodiments falling within the scope of the appended claims.

What is claimed is:

1. A cleaner sorting system comprising:
a storage rack having a first rail and a second rail attached together using a floor support member of the storage rack;
a storage member attached to the first rail and to the second rail;
a housing movably and permanently attached to the first rail and the second rail; wherein the housing has a visual indicator on an external surface thereof.

2. The cleaner sorting system of claim 1, further comprising:
a first bracket attached to the first rail and a second bracket attached to the second rail.

3. The cleaner sorting system of claim 2, further comprising:
a separator attached between the first bracket and the second bracket.

4. The cleaner sorting system of claim 1, further comprising:
an axle attached to the first rail and to the second rail.

5. The cleaner sorting system of claim 4, further comprising:
a housing support member attached to the housing and to the axle.

6. The cleaner sorting system of claim 5, further comprising:
a cam mounted on the axle and in contact with the housing support member.

7. The cleaner sorting system of claim 1, further comprising:
a cam attached to an axle that is attached to the first rail and the second rail, wherein the cam is in contact with
a housing support member attached to the housing and to the axle; characterized in that user actuated cam motion moves the housing into an UP or into a DOWN position.

8. The cleaner sorting system of claim 1, wherein the housing further comprises a movable housing that moves between:
a housing UP position and a housing DOWN position.

9. The cleaner sorting system of claim 8,
whereby the housing UP position does not impact the storage member.

10. The cleaner sorting system of claim 1, further comprising:
a flange extending from a bottom portion of the housing.

11. The cleaner sorting system of claim 10, wherein the flange further comprises:
a dual flange having a forward flange and rear flange with a space there between.

12. A product control system for order completion comprising:
a housing having a plurality of indicators, each indicator provides a human sensible indication of customer order status;
a plurality of delivery separators integrally associated with the housing, each delivery separator of said plurality of delivery separators has an indicator of the plurality of indicators associated with it;
a customer specific tag to be applied to each item of the order presented by a customer;
a computer including an operator interface and an output to each of said plurality of indicators, said operator interface including an input device allowing an operator to identify a customer and an item associated with said customer; and
a scanning device capable of reading each customer specific tag and providing an input to said computer that said customer specific tag has been scanned.

13. The product control system for order completion of claim 12, wherein the plurality of deliver separators further comprise:
a plurality of flanges extending from a bottom portion of the housing.

14. The product control system for order completion of claim 13, wherein the dual flange further comprises:
a dual flange having a forward flange and rear flange with a space there between.

15. A method for sorting and assembling items prepared for delivery to a customer comprising:
associating an item specific, customer specific identification tag on each item to be prepared;
entering each item identification into a computer control system and monitoring the progress of each item in the preparation process; wherein each item forms a portion of an order identifiable with a specific customer;
processing all items to be prepared;
retrieving an item that has been prepared and using said tag to identify the item to the computer control system;
activating a human sensible indicator integrally and directly associated with a movable housing movably attached to a rack, wherein the human sensible indicator at the movable housing is above an assembly location for items on the rack for items belonging to a particular order such that a human operator may move the retrieved item to the assembly location;
repeating the retrieving an item and the activating a human sensible indicator steps above until all items in a particular order have been assembled; and
activating a human sensible indicator on said assembly location to indicate the order is complete.

16. The method for sorting and assembling items of claim 15, further comprising: prepared for delivery to a customer wherein the movable housing is moved into an UP position.

17. The method for sorting and assembling items of claim 15, wherein said human sensible indicator is an addressable LED.

18. The method for sorting and assembling items of claim 17, wherein said addressable LED is addressable by said computer control system.

19. The method for sorting and assembling items of claim 17, wherein said addressable LED is illuminated for a preset period of time to allow said operator to move said item to the associated location.

20. The method for sorting and assembling items of claim 15, wherein said computer control system includes a graphical user interface displaying the status of selected open orders and garments being retrieved, wherein said graphical user interface displays the assembly location and the items retrieved to said assembly location.
